(19) United States
(12) Patent Application Publication
(10) Pub. No.: US 2015/0166017 A1
(43) Pub. Date: Jun. 18, 2015

(54) WINDSCREEN WIPER DEVICE

(71) Applicant: Federal-Mogul Motorparts Corporation, Southfield, MI (US)

(72) Inventors: William D. Young, III, Waterford, MI (US); Dennis E. Cox, Belleville, MI (US)

(21) Appl. No.: 14/572,101

(22) Filed: Dec. 16, 2014

Related U.S. Application Data
(60) Provisional application No. 61/916,538, filed on Dec. 16, 2013.

(51) Int. Cl. B60S 1/40

(52) U.S. Cl. CPC B60S 1/4003; B60S 1/4006; B60S 1/4077; B60S 1/4045; B60S 2001/408

(57) ABSTRACT

The windscreen wiper device includes a longitudinally extending wiper strip of a flexible material for sealing against a windshield. The wiper device further includes a carrier element which operably supports the wiper strip and a two piece connecting device that is secured with the carrier element for attachment with a wiper arm. The two piece connecting device includes a base which is fixed with the carrier element and an adapter which is pivotally connectable with the base. The adapter is formed as one integral piece and includes a button for releasable engagement within an opening of a bayonet-style wiper arm, a pair of rear locking tabs for receiving legs of a rock and lock-style wiper arm, a front nose portion for releasable engagement with a front edge of the rock and lock-style wiper arm and a single cantilever beam for releasable engagement with hook-style and transverse pin-style wiper arms.

### CROSS-REFERENCE TO RELATED APPLICATION

This application claims the benefit of U.S. Provisional Patent Application Serial No. 61/916,538, filed Dec. 16, 2014, entitled “Windscreen Wiper Device”, the entire disclosure of the application being considered part of the disclosure of this application and hereby incorporated by reference.

### BACKGROUND OF THE INVENTION

1. Field of the Invention

The present invention is related to windscreen wiper devices, or wiper blade assemblies, and more precisely to connector assemblies for connecting wiper blade assemblies to different types of wiper arms.

2. Related Art

Passenger vehicles may have any one of a range of different styles of oscillating wiper arms including, for example, various sizes of hook-style wiper arms, pin-style wiper arms, bayonet-style wiper arms and rock lock-style wiper arms. Twelve of the most common types of wiper arms are 9×3, 9×4×23, 9×4×28 and 9×4×33 sized hook-style wiper arms; 19 and 22 mm sized bayonet-style wiper arms; 19 mm and 22 mm side-pin style wiper arms; 3/16″ and ¼″ sized cylindrical pin-style wiper arms; and two different sizes of rock lock-style wiper arms.

Some aftermarket wiper blade assemblies are sold as expendable articles with a connector assembly which can only be attached to a single type of wiper arm. Others are packaged and sold with interchangeable parts to allow the wiper blade assembly to be operably attached with two or more of the above-referenced types of wiper arms commonly found on vehicles. Aftermarket wiper blades that are configurable to be operatively attached with all twelve of the above-referenced styles and sizes of wiper arms typically include a base and four or more adapters which are connectable to the base. Each of the adapters is designed for receiving and operably engaging one or more type and/or size of wiper arm.

### SUMMARY OF THE INVENTION

One aspect of the present invention provides for a windscreen wiper device including a longitudinally extending wiper strip of a flexible material for sealing against a windshield. The wiper device further includes a carrier element which operably supports the wiper strip and a two piece connecting device that is secured with the carrier element for attachment with a wiper arm. The two piece connecting device includes a base which is fixed with the carrier element and an adapter which is pivotally connectable with the base. The adapter is formed as one integral piece and includes a button for releasable engagement within an opening of a bayonet-style wiper arm, a pair of rear locking tabs for receiving legs of a rock and lock-style wiper arm, a front nose portion for releasable engagement with a front edge of the rock and lock-style wiper arm and a single cantilever beam for releasable engagement with hook-style and transverse pin-style wiper arms.

The adapter is advantageous as compared to other known adapters because it is capable of connection with a wider range of different styles of wiper arms than other known adapters and without any additional parts that could cause confusion for a user attempting to join the wiper device with a wiper arm on his or her vehicle. The adapter also allows for reduced manufacturing costs through economies of scale since two or more adapters do not have to be produced for attaching with the various different styles of wiper arms.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is an isometric view of an exemplary embodiment of a windscreen wiper device;

FIG. 2 is another isometric view of the exemplary embodiment of the windscreen wiper device taken from a different perspective than FIG. 1;

FIG. 3 is a fragmentary view of an exemplary connecting device of the windscreen wiper device of FIG. 1 an joined with a carrier element;

FIG. 4 is an exploded view of the connecting device of FIG. 3;

FIG. 5 is an isometric view of an exemplary adapter of the connecting device of

FIG. 4;

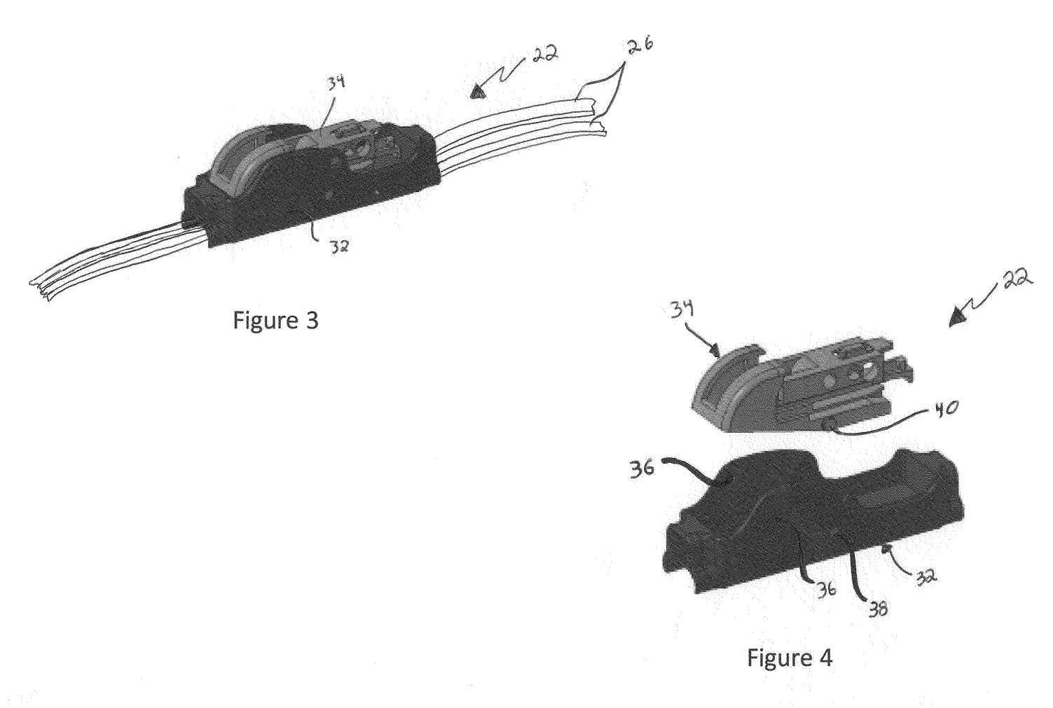

FIG. 6 is an isometric and fragmentary view of the connecting device of FIG. 3 attached with a 22 mm bayonet-style wiper arm;

FIG. 7 is an isometric and fragmentary view of the connecting device of FIG. 3 attached with 19 mm bayonet-style wiper arm;

FIG. 8 is another isometric and fragmentary view of the connecting device of FIG. 3 attached with a 19 mm bayonet-style wiper arm taken from a different perspective than FIG. 7;

FIG. 9 is an isometric and fragmentary view of the connecting device of FIG. 3 attached with a rock and lock-style wiper arm;

FIG. 10 is an isometric and fragmentary view of the connecting device of FIG. 3 attached with a rock and lock with window-style wiper arm;

FIG. 11 is an isometric and fragmentary view of the connecting device of FIG. 3 in a pre-engagement position before attachment with the rock and lock-style wiper arm;

FIG. 12 is an isometric and fragmentary view of the connecting device of FIG. 3 in a pre-engagement position before attachment with the rock and lock with window-style wiper arm;

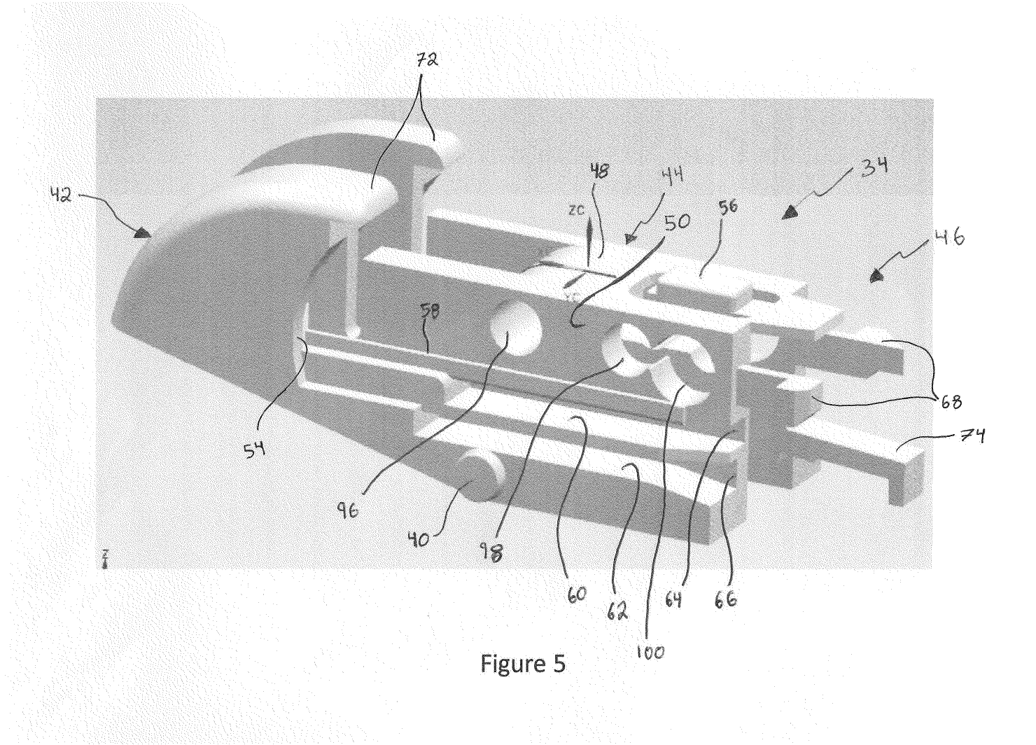

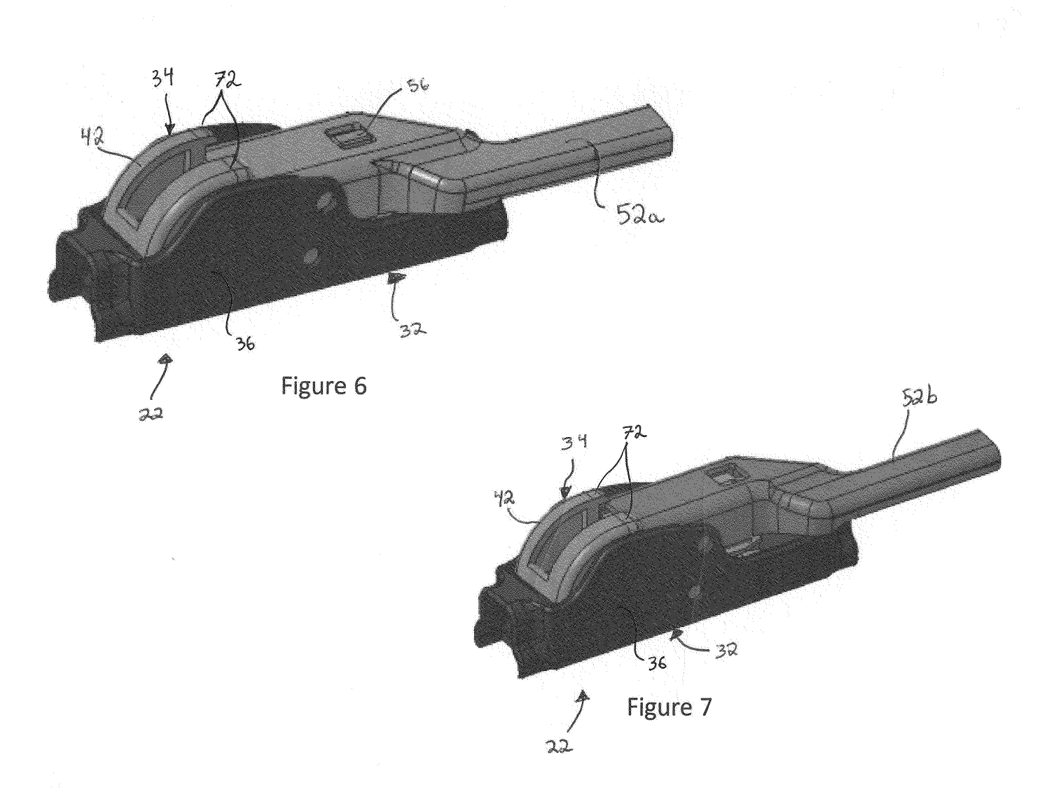

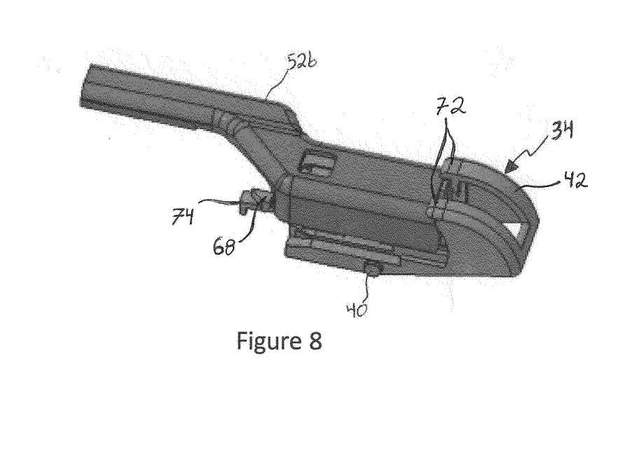

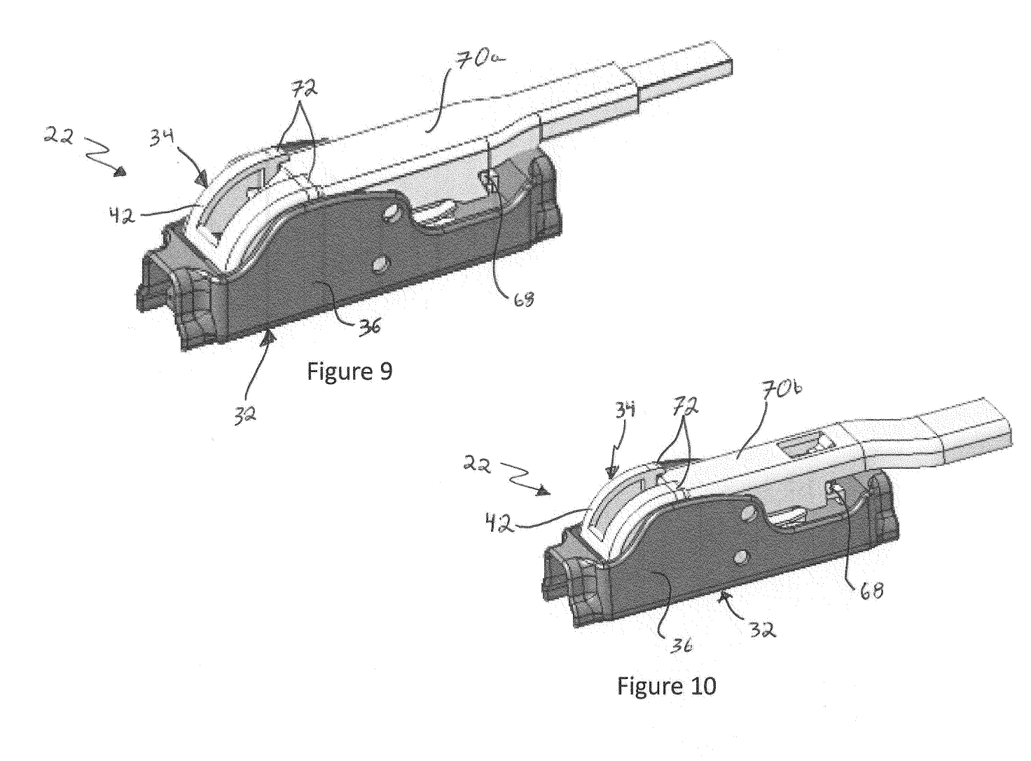

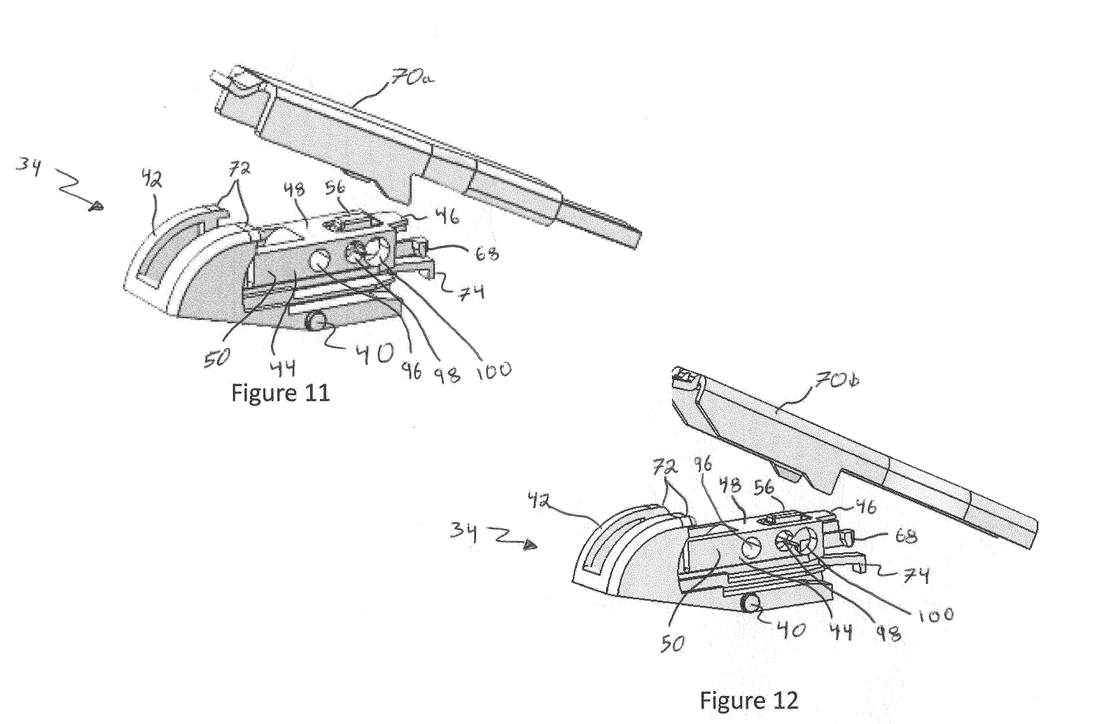

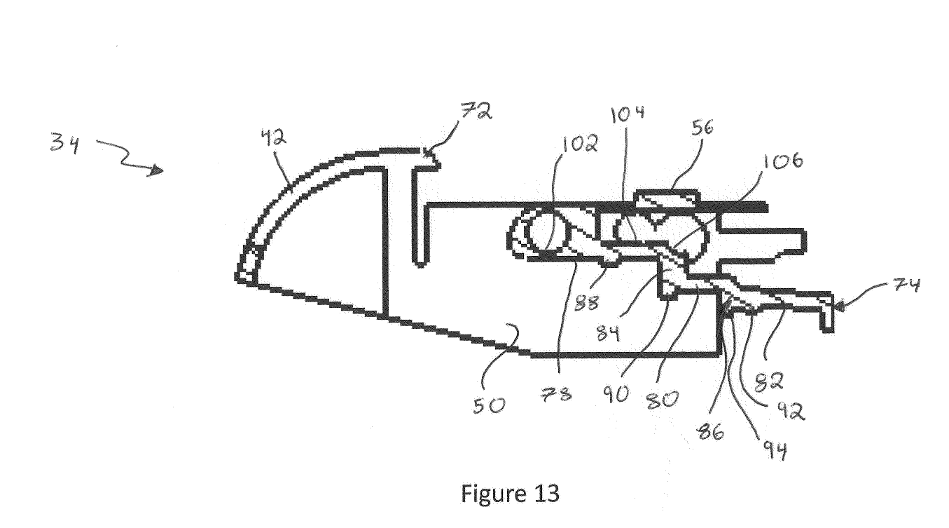

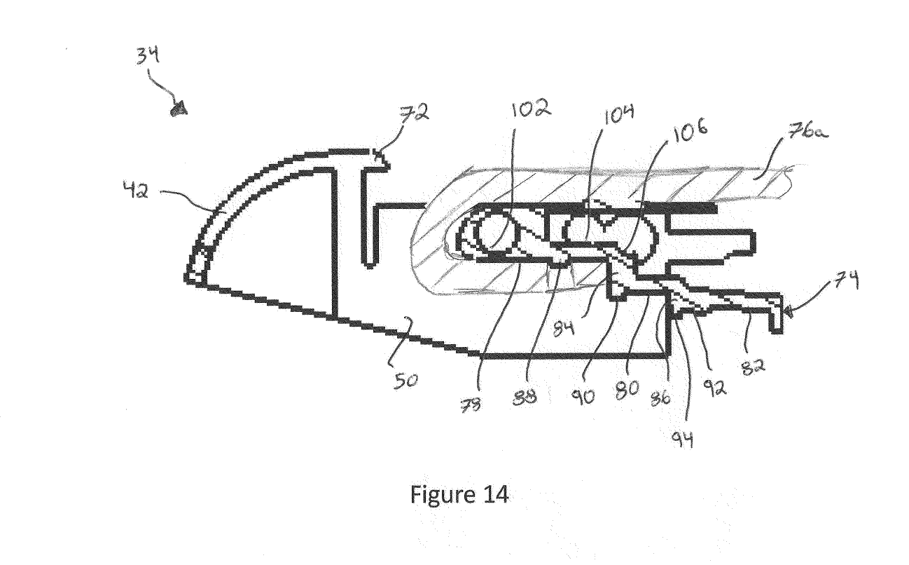

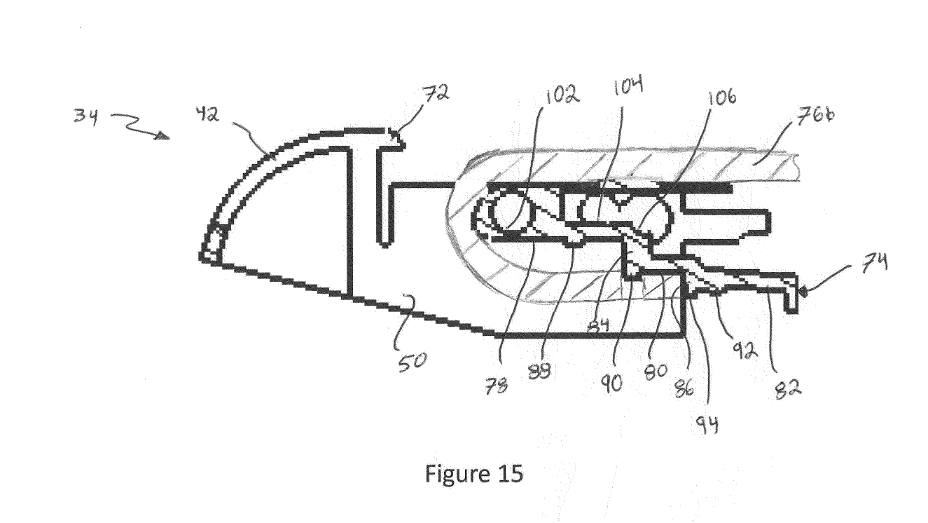

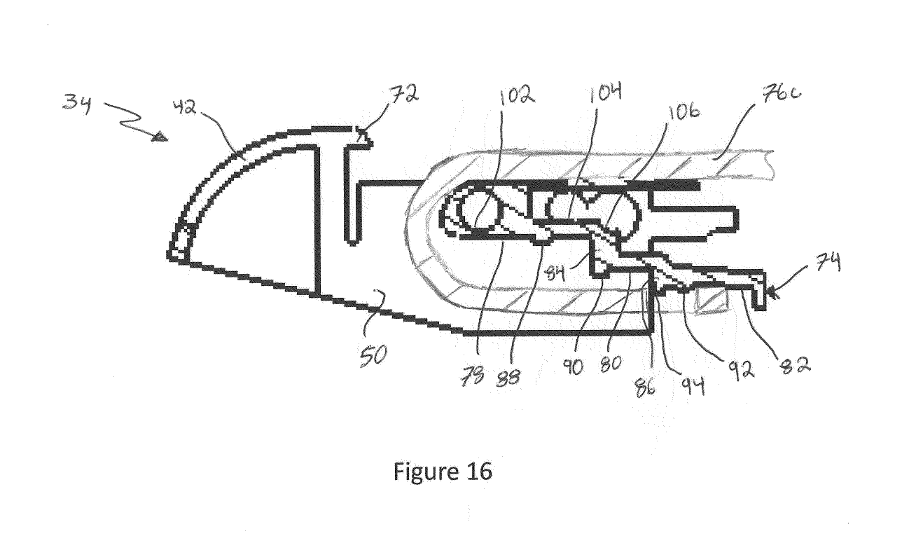

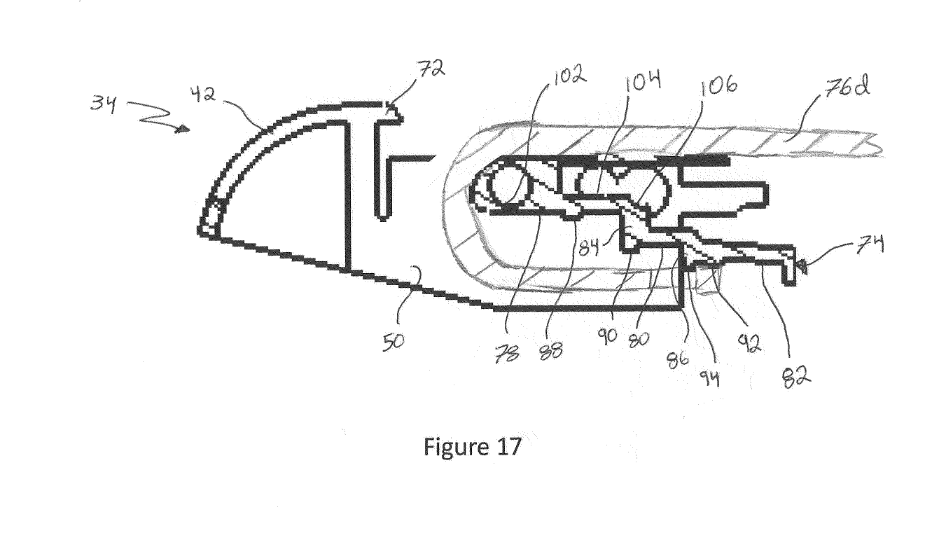

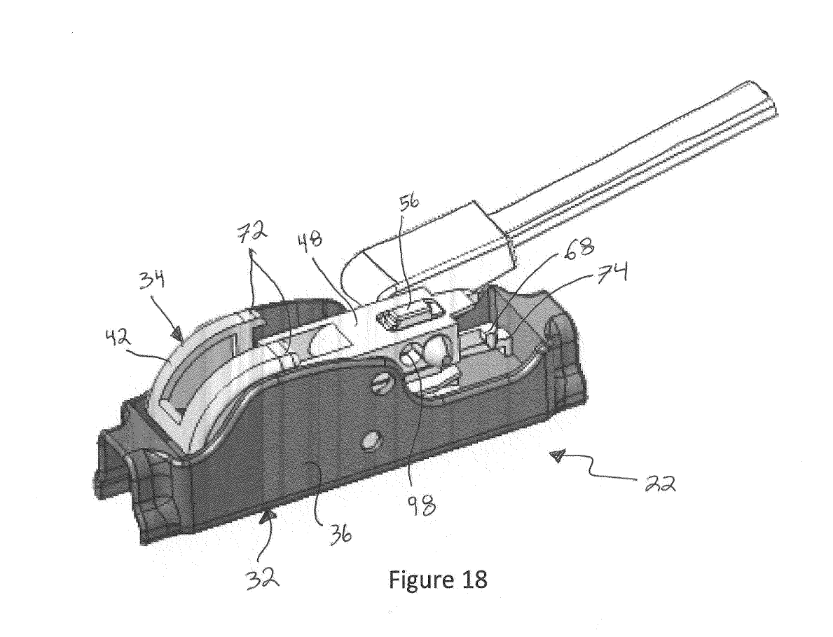

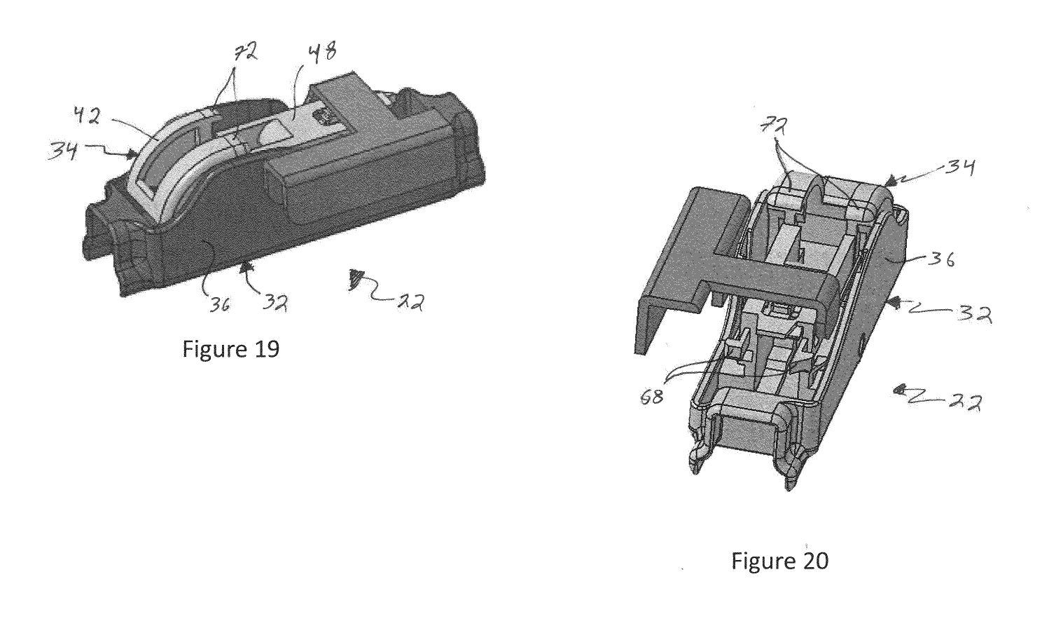

FIG. 13 is a cross-sectional view of the exemplary adapter of FIG. 5;

FIG. 14 is a cross-sectional and fragmentary view of the exemplary adapter of FIG. 5 attached with a 9×3 sized hook-style wiper arm;

FIG. 15 is a cross-sectional and fragmentary view of the exemplary adapter of FIG. 5 attached with a 9×4×23 sized hook-style wiper arm;

FIG. 16 is a cross-sectional and fragmentary view of the exemplary adapter of FIG. 5 attached with a 9×4×33 sized hook-style wiper arm;

FIG. 17 is a cross-sectional and fragmentary view of the exemplary adapter of FIG. 5 attached with a 9×4×28 sized hook-style wiper arm;

FIG. 18 is an isometric view of the connecting device of FIG. 13 connected with a ¼″ sized transverse pin-style wiper arm;

FIG. 19 is an isometric view of the connecting device of FIG. 13 connected with a 19 mm side pin-style wiper arm; and

FIG. 20 is an isometric view of the connecting device of FIG. 13 connected with a 22 mm side pin-style wiper arm.

### DESCRIPTION OF THE ENABLING EMBODIMENT

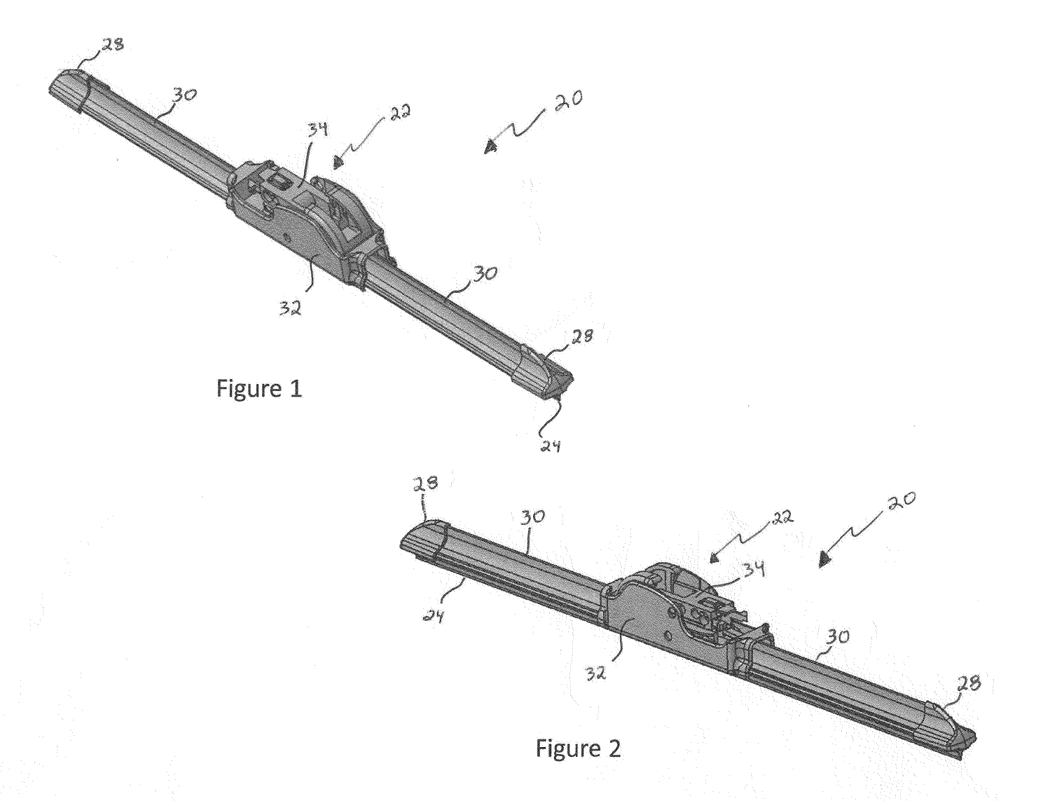

Referring to the Figures, wherein like numerals indicate corresponding parts throughout the several views, an exemplary embodiment of a windscreen wiper device 20, or a wiper blade assembly, is generally shown in FIGS. 1 and 2. The exemplary wiper device 20 a beam-style wiper blade (as opposed to a conventional-style wiper blade) and includes a two-piece connecting device 22 which is configured for connection with a wide range of different types of original equipment wiper arms without any special adapters or extra piece. More specifically, the exemplary connecting device 22 is configured for attachment with at least the following types and sizes of passenger vehicle wiper arms: 9×3, 9×4×23, 9×4×28 and 9×4×33 sized hook-style wiper arms; 19 and 22 mm sized bayonet-style wiper arms; 19 mm and 22 mm side pin-style wiper arms; 3/16″ and ¼″ sized cylindrical side pin-style wiper arms; and large and two different configurations of rock and lock-style wiper arms.

The exemplary embodiment of the wiper device 20 includes a longitudinally extending wiper strip 24 which is made of a flexible material, such as rubber, for sealing against a vehicle windshield for driving rain, snow, ice or other elements away therefrom. As shown in FIG. 3, a carrier element comprising a pair of flexors 26 is provided for biasing the wiper strip 24 (shown in FIGS. 1 and 2) into a pre-curved configuration. Specifically, the flexors 26 (also known as splines or longitudinal strips) are pre-curved for distributing a force from the wiper arm across the length of the wiper strip 24 to establish a generally uniform seal with the windshield along the longitudinal length of the wiper strip 24. Although the exemplary carrier element includes a pair of flexors 26, it should be appreciated that any suitable number of flexors could be employed. For example, the carrier element may include just a single flexor. Referring back to FIGS. 1 and 2, the exemplary wiper device 20 is also provided with a pair of end caps 28 and a pair of subspoilers 30 which extend from the connecting device to the end caps 28 for exerting a downforce against the wiper strip 24 to improve the seal between the wiper strip 24 and the windshield when the vehicle is travelling at speed.

The two-piece connecting device 22 is located at approximately a longitudinal midpoint of the exemplary wiper device 20. As shown in FIG. 3, the connecting device 22 is made of two pieces which are formed separately and are subsequently joined together. One of the pieces of the connecting device 22 is a base 32 which is fixed with the flexors 26, and the other piece is an adapter 34 which is pivotally coupled with the base 32 and is shaped to releasably connect with the various different sizes and styles of wiper arms listed above. The base 32 may be engaged with the flexors 26 through any suitable connection means including, for example, adhesives, heat staking, welding, material deformation, etc.

As best shown in FIG. 4, the exemplary base 32 has a pair of sidewalls 36 which extend vertically upwardly from a floor in spaced and parallel relationship with one another. The sidewalls 36 are provided with raised portions on one longitudinal side and recessed portions on the other longitudinal side. The raised portions of the sidewalls 36 present co-axial through holes 38 which are generally circular in shape to define a pivot axis for the pivoting connection between the adapter 34 and the base 32.

The adapter 34 is provided with opposing protrusions 40 which are circular in shape and are receivable within the through holes 38 of the base 32 to allow the adapter 34 to pivot relative to the base 32. As shown in FIG. 4, a lower surface of the adapter 34 is angled forwardly of the pivot for increasing the range of rotation of the adapter 34 relative to the base 32. The protrusions 40 of the adapter 34 are preferably received within the through holes 38 of the base 32 through a snap fitting process.

Referring now to FIG. 5, the exemplary embodiment of the adapter 34 is generally shown. Generally, the adapter 34 is divided into a front nose portion 42, a main body portion 44 which extends across the pivot axis established by the protrusions 40 and a rear portion 46 with the front nose portion 42 and the rear portion 46 being on opposite sides of the main body portion 44 from one another. The main body portion 44 is generally U-shaped with a top wall 48 and a pair of sides 50 that extend downwardly in spaced and parallel relationship with one another from the top wall 48.

As shown in FIGS. 5-8, the exemplary embodiment of the adapter 34 is shaped to connect with at least two different sizes of bayonet-style wiper arms 52a, 52b including a 22 mm bayonet-style wiper arm 52a and a 19 mm bayonet-style wiper arm 52b. To facilitate the connection with the 22 mm bayonet-style wiper arm 52a, the front nose portion 42 has a rearwardly facing surface 54 which is curved similarly to a front edge of the 19 mm bayonet-style wiper arm 52a, and the main body portion 44 is provided with a resilient latching tongue with a button 56 which projects above the top wall 48. The latching tongue is integrally connected with the top wall 48 adjacent the rear portion 46 of the adapter 34 for automatically springing into locking engagement within an opening in the 22 mm bayonet-style wiper arm 52a during the connecting process. Alternately, the latching tongue could be integrally connected with the top wall adjacent to the sides 50 or to the front nose portion 42.

The adapter 34 may be released from engagement with the 22 mm bayonet-style wiper arm 52a by pressing the button 56 through the opening in the wiper arm 52a and sliding the wiper arm 52a rearwardly. As shown in FIG. 5, the sides 50 of the main body portion 44 are provided with three ledges 58, 60, 62 (including an upper ledge 58, a middle ledge 60 and a lower ledge 62) which are all at different vertical heights from one another for supporting different styles and sizes of wiper arms. The sides 50 are provided with a first groove 64 between the upper and middle ledges 58, 60 and with a second groove 66 between the middle and lower ledges 60, 62. The second groove 66 is situated to receive a lower lip on the 22 mm bayonet-style wiper arm 52a.

In contrast to the 22 mm bayonet-style wiper arm 52a discussed above, connecting the 19 mm bayonet-style wiper arm 52b with the adapter 34 does not utilize the button 56 on the latching tongue. Rather, the rear portion 46 of the adapter 34 is provided with a pair of locking tabs 68 which project rearwardly from the main body portion 44 and laterally outwardly for engaging with a rear edge of the 19 mm bayonet-style wiper arm 52b as shown in FIG. 8. The rear edges of the locking tabs 68 are chamfered to automatically flex the locking tabs 68 inwardly towards one another when contacted by a front edge of the 19 mm bayonet-style wiper arm 52b. Also, when attached with the adapter 34, the lower lip of the 19 mm bayonet-style wiper arm 52b is received within the first grooves 64 as opposed to the second grooves 66 of the sides 50 which receive the lower lips of 22 mm bayonet-style wiper arms. The 19 mm bayonet-style wiper arm 52b may be detached from the adapter 34 by pressing the locking tabs 68 inwardly towards one another to disengage the locking tabs 68 from the back edges of the wiper arm 52b and then sliding the wiper arm 52b rearwardly relative to the adapter 34.

Referring now to FIGS. 9 and 10, the exemplary embodiment of the adapter is shown in engagement with a rock and lock-style wiper arm 70a and a rock and lock with window-style wiper arm 70b respectively. As shown in FIG. 5, the front nose portion 42 is hingedly connected with the main body portion 44 at a lower end thereof with a pair of living hinges that allows the nose portion 42 to resiliently pivot forwardly away from the main body portion 44. Opposite of the living hinges, the front nose portion 42 includes a pair of fingers 72 which are configured to engage with a top edge of the rock and lock and the rock and lock with window-style wiper arms 70a, 70b, as shown in FIGS. 9 and 10. With reference to FIGS. 9-12, to connect either of these wiper arms 70a, 70b, a user first engages the back legs of the respective of the respective wiper arm 70a, 70b with the locking tabs 68 on the rear portion 46 of the adapter 34. Next, the user pivots the adapter 34 about the contact surfaces between the locking tabs 68 and the wiper arm 70a, 70b until the fingers 72 on the nose portion 42 snap into engagement with the top edge of the wiper arm 70a, 70b. Either style of wiper arm 70a, 70b can be released from the adapter 34 by urging the nose portion 42 forwardly to disengage the fingers 42 from the top edge of the wiper arm 70a, 70b and then pivoting the adapter 34 relative to the wiper arm 70a, 70b in the opposite direction from which it was attached.

Referring now to FIG. 13, the exemplary embodiment of the adapter 34 includes a single cantilever beam 74 which extends from a front land of the top wall 48 of the main body portion 44 to the rear portion 46 for engaging within openings of differently sized hook-style wiper arms 76a, 76b, 76c, 76d.

The cantilever beam 74 extends through a series of bends or curves which are separated longitudinally from one another by a plurality of landings 78, 80, 82. The landings 78, 80, 82 are specifically located for slidably engaging the lower legs of differently sized hook-style wiper arms 76a, 76b, 76c, 76d. In the exemplary embodiment, the cantilever beam 74 includes a total of three landings 78, 80, 82, which are hereinafter referred to as a first landing 78, a second landing 80 and a third landing 82. The first and second landings 78, 80 are separated from one another by a first vertical portion 84, and the second and third landings 80, 82 are separated from one another by a second vertical portion 86.

As shown in FIG. 14, the first landing 78 includes a first protrusion 88 for locking into engagement with a hole in the lower portion of a 9×3 sized hook-style wiper arm 76a. During the process of attaching the 9×3 sized hook-style wiper arm 76a with the adapter 34, the first vertical portion 84 serves as a stopping point for limiting movement of the adapter 34 relative to the wiper arm 76a. Longitudinal movement of the adapter 34 and the hook-style wiper arm 76a relative to one another is restricted in one direction by the first vertical portion 84 and in the other direction the first protrusion 88.

Referring to FIGS. 13 and 15, the first vertical portion 84 of the cantilever beam 74 extends in a vertical direction between the first and second landings 78, 80 and includes a second protrusion 90 which projects vertically downwardly below the second landing 86 for locking into engagement with a hole in the lower leg of a 9×4×23 sized hook-style wiper arm 76b. The second protrusion 90 is spaced longitudinally behind and vertically below the first protrusion 88. When connected with a 9×4×23 sized hook-style wiper arm 76b, longitudinal movement of the adapter 34 and the wiper arm 76b relative to one another is restricted in one direction by the front land and the second vertical portion 86 and in the other direction by the second protrusion 90.

The second vertical portion 86 of the cantilever beam 74 extends at an angle relative to the parallel second and third landings 80, 82. A third protrusion 92 projects vertically downwardly from the second vertical portion 86 and from the third landing 82. The third protrusion 92 is spaced longitudinally behind and vertically below the second protrusion 90. As shown in FIG. 16, the third protrusion 92 is adapted to engage with a hole in the lower leg of a 9×4×33 sized hook-style wiper arm 76c. Longitudinal movement of the adapter 34 and the 9×4×33 sized hook-style wiper arm 76c is restricted in both directions by the third protrusion 92.

Referring now to FIG. 17, the third protrusion 92 also includes a tab 94 extending downwardly therefrom for engaging with a hole in the lower leg of a 9×4×28 sized hook-style wiper arm 76d. Longitudinal movement of the adapter 34 and the 9×4×28 sized hook-style wiper arm 76d is restricted in one direction by the tab 94 and in the other direction by the front land.

As shown in FIG. 13, each of the first, second and third protrusions 88, 90, 92 has a forwardly-facing ramped or angled surface for snappingly engaging the holes in the respective hook-style wiper arms 76a, 76b, 76c, 76d to which they are configured for engagement. During the process of attaching the adapter 34 with any of the 9×3, 9×4×23, 9×4×33 and 9×4×28 sized hook-style wiper arms 76a, 76b, 76c, 76d, the end of the respective wiper arm contacts one of the ramped surfaces, which causes the cantilever beam 74 to deflect resiliently at the hinge. Once the wiper arm 76a, 76b, 76c, 76d has travelled a predetermined distance relative to the adapter 34, the cantilever beam 74 automatically snaps downwardly with one of the protrusions 88, 90, 92 engaging into the hole in the lower leg of the wiper arm 76a, 76b, 76c, 76d. This provides an audible signal to a user that a secure connection has been established between the adapter 34 and the wiper arm 76a, 76b, 76c, 76d. This same process allows for connection to any of the four different sizes of hook-style wiper arms 76a, 76b, 76c, 76d.

The adapter 34 may be detached from the wiper arm by manually urging the back end of the cantilever beam 74 in an upward direction to disengage the one of the engaged protrusions 88, 90, 92 from the hole in the respective hook-style wiper arm 76a, 76b, 76c, 76d.

This allows the adapter 34 to be slid longitudinally away from the wiper arm. This same process may be used for detachment of any of the 9×3, 9×4×23, 9×4×33 and 9×4×28 sized hook-style wiper arms 76a, 76b, 76c, 76d.

The front nose portion 42 and the middle body portion 44 are provided with opposing slots to facilitate the connection and detachment of the adapter 34 with the hook-style wiper arms 76a, 76b, 76c, 76d. Specifically, the slot in the front nose portion 42 is positioned laterally between the fingers 72. The slot in the middle body portion 44 faces towards the slot in the front nose portion 42.

Referring back to FIG. 13, each of the sides of the adapter 34 has three openings 96, 98, 100 which are longitudinally spaced from one another and extend through the adapter 34 for receiving the differently-sized pins of pin-style wiper arms, and the cantilever beam 74 includes first, second and third pin engagement portions 102, 104, 106 for lockingly engaging within grooves of those pins. Specifically, the first opening 96 and the first pin engagement portion 102, which are closest to the front nose portion 42, is configured to receive and engage with pins which are approximately 19 mm and 22 mm in size. The second or middle opening 98 and the second pin engagement portion 104 are configured to receive and lockingly engage within grooves of 3/16″ pins, and the third opening 100 and the third pin engagement portion 106 are configured to receive and lockingly engage within grooves of ¼″ pins. FIGS. 19 and 20 show the connecting device 20 in connection with the 19 and 22 mm side pin-style wiper arms respectively.

Detachment of the adapter 34 from any of the cylindrical pin-style wiper arms simply requires urging the cantilever beam 74 downwardly at the rear portion 46 to disengage the respective one of the pin engagement portions 104, 106 from the groove of the respective pin and pulling the pin out of the respective opening 96, 98, 100. As such, the same process may be employed to detach the adapter 34 from the 3/16″ and ¼″ sized cylindrical pin-style wiper arms. For the 19 mm and 22 mm side pin-style wiper arms, detachment involves rotating the adapter 34 relative to the wiper arm until a leg on the wiper arm disengages from the adapter 34 and pulling the pin through the opening 96.

Obviously, many modifications and variations of the present invention are possible in light of the above teachings and may be practiced otherwise than as specifically described while within the scope of the appended claims.

What is claimed is:

1. A windscreen wiper device, comprising:
a longitudinally extending wiper strip of a flexible material for sealing against a windshield;
a carrier element operably supporting said wiper strip;
a two piece connecting device secured with said carrier element for attachment with a wiper arm, said two-piece connecting device including a base which is fixed with said carrier element and an adapter which is pivotally connectable with said base;
said adapter being formed as one integral piece and including a button for releasable engagement within an opening of a bayonet-style wiper arm, a pair of rear locking tabs for receiving legs of a rock and lock-style wiper arm, a front nose portion for releasable engagement with a front edge of the rock and lock-style wiper arm, and a single cantilever beam for releasable engagement with hook-style and transverse pin-style wiper arms.

2. The windscreen wiper device as set forth in claim 1 wherein said cantilever beam includes a plurality of landings and a plurality of protrusions for engaging within openings of at least 9×3, 9×4×23, 9×4×28 and 9×4×33 hook-style wiper arms.

3. The windscreen wiper device as set forth in claim 2 wherein said plurality of landings on said cantilever beam is three landings and wherein said plurality of protrusions on said cantilever beam is three protrusions.

4. The windscreen wiper device as set forth in claim 1 wherein said adapter includes at least one opening and wherein said cantilever beam has at least one pin engagement portion for engaging within a groove of the pin-style wiper arm.

5. The windscreen wiper device as set forth in claim 4 wherein said adapter includes three openings and wherein said cantilever beam has three pin engagement portions for engaging within grooves of three differently sized pin-style wiper arms.

6. The windscreen wiper device as set forth in claim 1 wherein said front nose portion includes a slot for facilitating the connection of hook-style wiper arms with said adapter.

7. The windscreen wiper device as set forth in claim 6 wherein both said front nose portion and said main body portion include slots for facilitating the connection of hook-style wiper arms with said adapter.

8. The windscreen wiper device as set forth in claim 1 wherein said adapter includes sides with three vertically spaced ledges including a first ledge and a second ledge and a third ledge.

9. The windscreen wiper device as set forth in claim 8 further including a pair of grooves between said first, second and third ledges.

10. The windscreen wiper device as set forth in claim 1 wherein said front nose portion is resiliently connected with said main body portion and is pivotable relative thereto.

11. The windscreen wiper device as set forth in claim 1 wherein said adapter has a top wall with a resilient latching tongue and wherein said button is disposed on said resilient latching tongue.

12. The windscreen wiper device as set forth in claim 1 wherein said base includes a pair of sidewalls.

13. The windscreen wiper device as set forth in claim 12 wherein said sidewalls include co-axial through holes and wherein said adapter includes protrusions received within said through holes to establish said pivotal connection between said adapter and said base.

14. The windscreen wiper device as set forth in claim 1 wherein said carrier element includes a pair of flexors.
